(19) United States
(12) Patent Application Publication
(10) Pub. No.: US 2009/0014560 A1
(43) Pub. Date: Jan. 15, 2009

(54) Rear Cover Structure of Hydraulic Gun

(76) Inventor: Wenli KUO, Fangyuan Hsiang (TW)

Correspondence Address: Dr. BANGER SHIA, 102 Lindencrest Ct., Sugar Land, TX, 77479-5201, US

(21) Appl. No.: 12/126,856

(22) Filed: May 23, 2008

(30) Foreign Application Priority Data
Jul. 9, 2007 (CN) 200720007604.4

(51) Int. Cl. B05B 15/06

(52) U.S. Cl. 239/531; 16/404

(57) ABSTRACT

A rear cover structure of a hydraulic gun includes a rear cover and a tag. The rear cover is mounted on the hydraulic gun in a detachable way. The tag is connected to the rear cover. The tag has a ring hole for convenient hang and taking. This design is adapted to various hydraulic guns and is convenient to storage when not in use so as to avoid any damage to the hydraulic gun.

### BACKGROUND OF THE INVENTION

1. Field of the Invention

The present invention relates to a rear cover structure of a hydraulic gun for gardening purpose, and more particularly to a rear cover structure for convenient hang and taking.

2. Description of the Prior Art

There are various hydraulic guns for gardening purpose on the market, which have different functions and structures. The main function of the hydraulic gun for gardening purpose is to sprinkle water on the garden when the hydraulic gun is connected with a water pipe.

In general, when the hydraulic gun is not in use, the hydraulic gun is stored in a toolroom, hanged on a tool stand, or placed on the ground at random. This may cause damages to the hydraulic gun, sometimes it is not easy to find out a desired hydraulic gun.

Accordingly, the inventor of the present invention has devoted himself based on his many years of practical experiences to the development of a rear cover structure for a hydraulic gun for convenient storage and taking to overcome the above shortcomings.

### SUMMARY OF THE INVENTION

The purpose of the present invention is to provide a rear cover structure of a hydraulic gun for convenient storage and taking so as to avoid any damage to the hydraulic gun.

To achieve the purpose of the present invention, the present invention comprises a rear cover and a tag, the rear cover being mounted on the hydraulic gun in a detachable way, the tag being connected to the rear cover, the tag having a ring hole for convenient hang and taking.

The detachable way is a connection of threads, the rear cover having outer threads corresponding to and engaging with a water outlet of the hydraulic gun.

The tag has an inner edge formed with a restricting groove.

The tag is in a rectangular, circular or other shape.

The ring hole of the tag is in a rectangular, circular or other shape.

It is the primary object of the present invention to provide a rear cover structure of a hydraulic gun, which provides a tag for convenient storage when not in use.

It is another object of the present invention to provide a rear cover structure of a hydraulic gun, which is not easy to cause any damage to the hydraulic gun.

### BRIEF DESCRIPTION OF THE DRAWINGS

FIG. 1 is an exploded view of a preferred embodiment of the present invention incorporating with a first conventional hydraulic gun; and

FIG. 2 is an assembled view of the preferred embodiment of the present invention incorporating with the first conventional hydraulic gun;

FIG. 3 is an assembled view of the preferred embodiment of the present invention incorporating with a second conventional hydraulic gun;

FIG. 4 is an assembled view of the preferred embodiment of the present invention incorporating with a third conventional hydraulic gun;

FIG. 5 is an assembled view of the preferred embodiment of the present invention incorporating with a fourth conventional hydraulic gun;

FIG. 6 is an assembled view of the preferred embodiment of the present invention incorporating with a fifth conventional hydraulic gun;

### DETAILED DESCRIPTION OF THE INVENTION

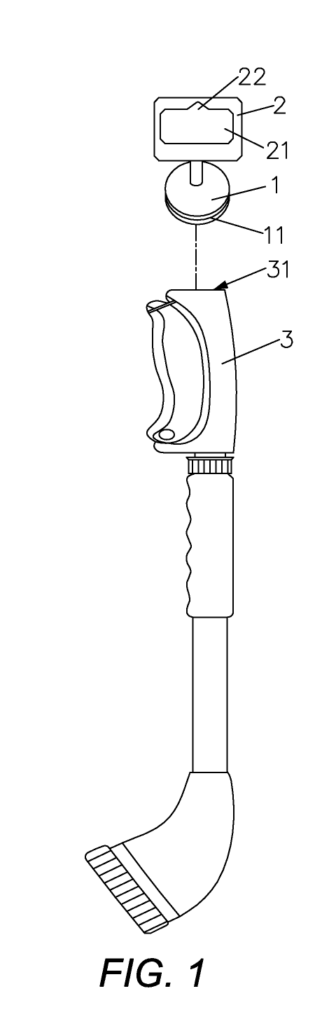

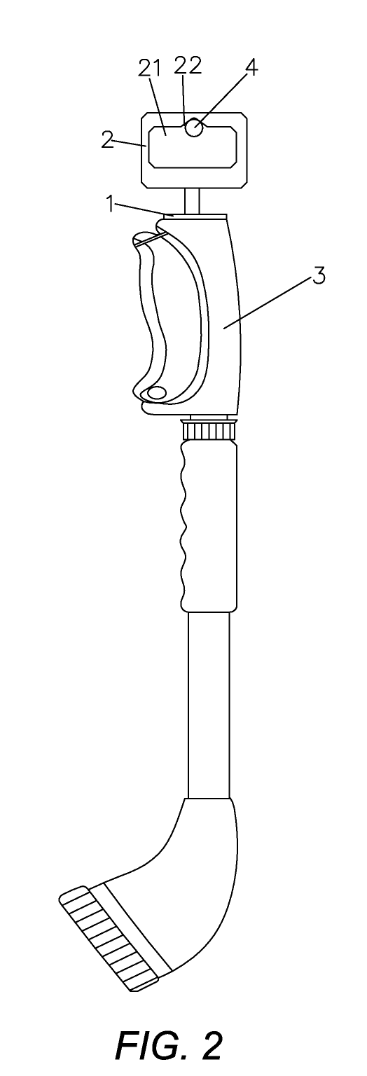

As shown in FIGS. 1 and 2, a rear cover structure of a hydraulic gun according to a preferred embodiment of the present invention comprises a rear cover 1 and a tag 2.

The rear cover 1 is mounted on a hydraulic gun 3 by in a detachable way. The rear cover 1 is not integrally formed with the hydraulic gun 3. In this embodiment, the rear cover 1 has outer threads 11 corresponding to and engaging with a water inlet 31 of the hydraulic gun 3.

The tag 2 is connected to the rear cover 1. The shape of the tag 2 is not limited, which may be a rectangle, a circle, or other shape. The tag 2 has a ring hole 21. The shape of the ring hole 21 is not limited, which may be a rectangle, a circle, or other shape. The inner edge of the ring hole 21 is formed with a restricting groove 22. When the tag 2 is hanged on a hook 4, the restricting groove 22 will engage with the hook 4 so that the tag 2 is confined to swing.

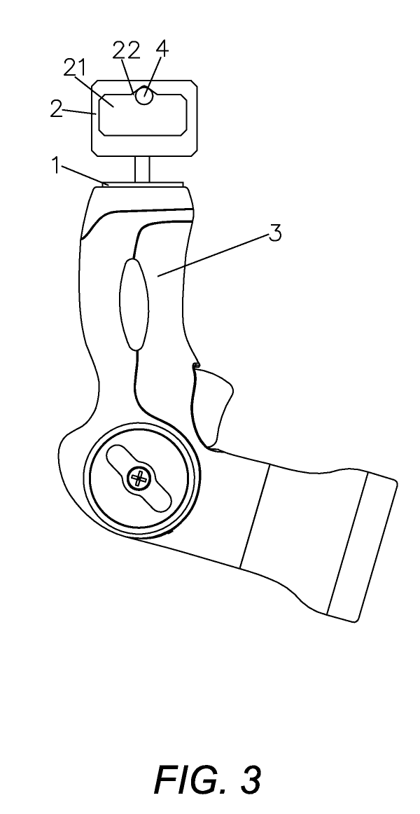

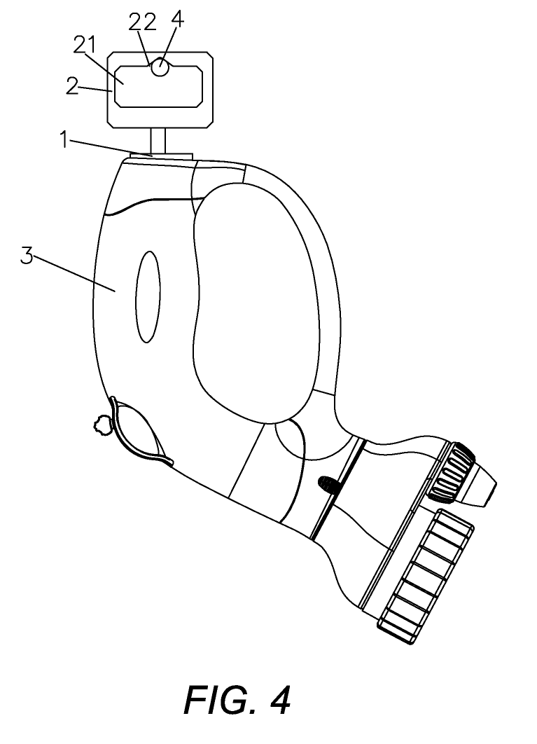

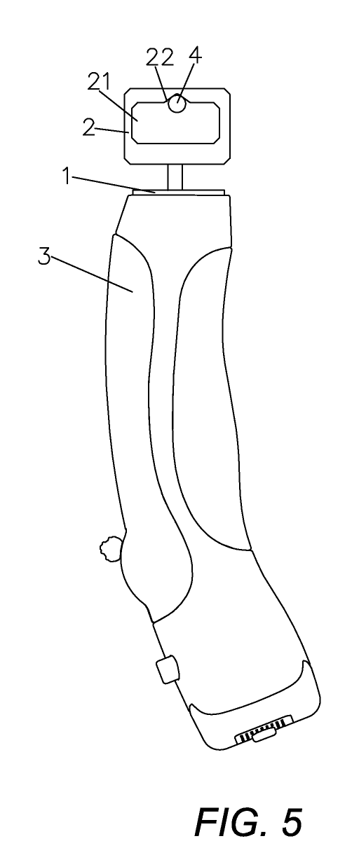

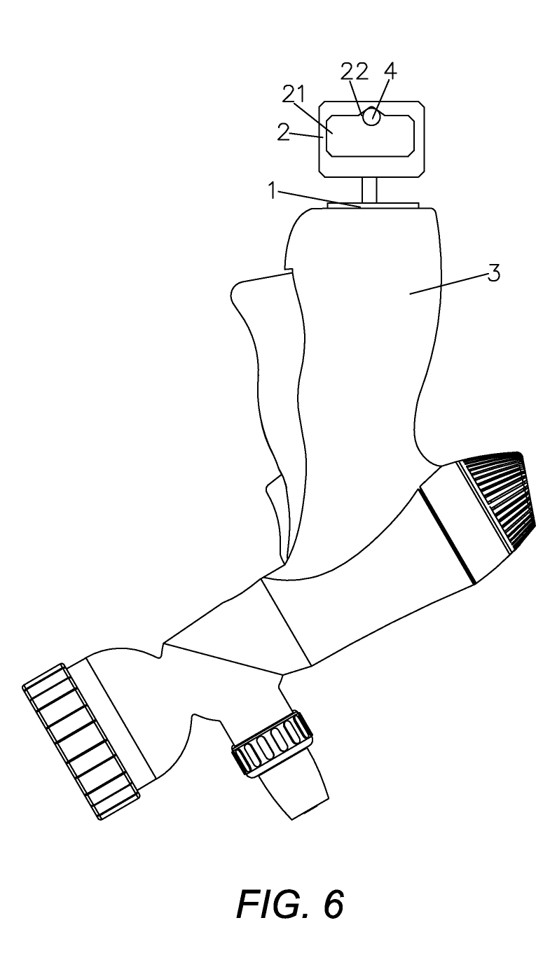

The present invention is adapted to various hydraulic guns 3, as shown in FIG. 2 through FIG. 6. The functions and structures of the various hydraulic guns 3 are not relevant to the present invention.

When the present invention is in use, the rear cover 1 is mounted on the hydraulic gun 3. When the hydraulic gun 3 is not in us, the tag 2 is hanged on the hook 4 of a wall or a stand to avoid any damage to the hydraulic gun 3. It is easy and convenient to recognize the hanging hydraulic gun 3.

Although the present invention has been shown and described with respect to the preferred embodiment, it will be understood by those skilled in the art that various changes and modifications may be made without departing from the spirit and scope of the invention as defined in the following claims.

What is claimed is:

1. A rear cover structure of a hydraulic gun comprising a rear cover and a tag, said rear cover being mounted on the hydraulic gun in a detachable way, said tag being connected to said rear cover, said tag having a ring hole for convenient hang and taking.

2. The rear cover structure of a hydraulic gun as claimed in claim 1, wherein said detachable way is a connection of threads, said rear cover having outer threads corresponding to and engaging with a water outlet of the hydraulic gun.

3. The rear cover structure of a hydraulic gun as claimed in claim 1, said tag has an inner edge formed with a restricting groove.

4. The rear cover structure of a hydraulic gun as claimed in claim 1, said tag is in a rectangular shape.

5. The rear cover structure of a hydraulic gun as claimed in claim 1, said tag is in a circular shape.

6. The rear cover structure of a hydraulic gun as claimed in claim 1, said ring hole of said tag is in a rectangular shape.

7. The rear cover structure of a hydraulic gun as claimed in claim 1, said ring hole of said tag is in a circular shape.
